(19) United States
(12) Patent Application Publication
(10) Pub. No.: US 2026/0023365 A1
(43) Pub. Date: Jan. 22, 2026

(54) Monolithic 3D AI computer system

(71) Applicant: Banqiu Wu, Katy, TX (US)

(72) Inventor: Banqiu Wu, Katy, TX (US)

(21) Appl. No.: 18/778,979

(22) Filed: Jul. 20, 2024

(51) Int. Cl. G05B 19/4099

(52) U.S. Cl. CPC G05B 19/4099; G05B 2219/49023

(57) ABSTRACT

A monolithic 30 AI computer system is disclosed. It is a monolithic 3D IC chip comprising a GPU and/or CPU, thermoelectric-cooler, high bandwidth memory IC, and TSV interconnections. It has a higher number of interconnections, higher data communication rate, and more compact structure. The heat generated in the 3D IC chip is dissipated by the thermoelectric-cooler.

### FIELD

The embodiments of the present disclosure generally relate to an artificial intelligence (AI) computer system. More particularly, embodiments of the present disclosure relate to a monolithic three dimensional (3D) fabricated AI computer system with self-cooled integrated circuit (IC).

### BACKGROUND

Recently, AI technologies have become the most competitive ones in the world it is predicted that AI will have more and more applications in the future. AI applications in autopilot, face identification, expert systems, medical diagnosis, military weapons, etc. have been validated. Economically, it is believed that the market size for applications of AI is as high as one trillion dollars per year in the future. Therefore, more and more powerful AI systems are in demand.

Current AI systems have a special machine learning capability, which makes it different from previous modeling systems The AI application feasibility depends on calculation speed, data transfer rate, and data size, all of which heavily rely on the microchip's performance. It is the semiconductor manufacturing technology advancements in recent years that make the graphics processing unit (GPU) very powerful. Presently, GPU technologies have made revolutionary changes in AI capability that usher us into a new era of AI.

AI's specialty is its learning or training capability, which is based on big data. This means that AI necessitates working in conjunction with a large data center. Because AI's applications cover a broad range of areas in people's daily lives, industrial production, and almost every corner of our society, there will be strong demand in the future for a variety of AI ecosystems.

Current AI computer systems consist of a GPU, high bandwidth memory (HBM), dynamic random access memory (DRAM), and solid state drive (SSD). The interconnection data transfer rate between the GPU and high bandwidth memory became the most critical parameter for determining the performance of an AI computer system.

AI computer system performance heavily depends on the computer system calculation capability. Therefore, AI system performance is mainly determined by the system performance indicators such as transistor gate delay, interconnect delay, internal memory data transfer rate, and external memory data transfer rate.

In order to overcome the gate delay and increase memory size, smaller feature sizes of integrated circuits have been enhanced by different lithographic technologies. Since the 1980s, projection lithography has used increasingly shorter and shorter exposure wavelength for better IC resolution, from 436 nm (g-line) to 365 nm (i-line), 248 nm (deep ultraviolet), 193 nm (deep ultraviolet), 193 nm immersion, to the current most advanced 13.5 nm (extremely ultraviolet, i.e. EUV) lithography.

Since 2000, gate delay has become less critical as interconnect delay in an IC has become more and more significant and as internal memory data transfer rate became relatively slow (also called the “memory wall”). To solve these challenges, more and more cores are used on GPU and CPU microchips. However, multiple core approaches for GPU and CPU have almost reached their current technological limit.

For the purpose of making faster computer systems, another approach to overcoming these limits is given more attention, namely, the monolithic 3D IC, which reduces interconnect delay and eliminates the memory wall because the monolithic 3D IC can provide a higher number of interconnects and shorten interconnect distances.

High bandwidth memory based on 3D IC stacking technology has been proposed and is now used in high end AI computer systems to allow for a high memory data transfer rate, but the data transfer rate between the GPU and high bandwidth memory is limited by the data bus. The more bits in the data bus, the higher the data transfer rate. However, the number of the bus bits is limited by the geometric dimensions of the microchip system. Currently, data busses reach as high as about 5000 bits, but higher bandwidth is in strong demand for AI computer system performance improvement.

The interposer, GPU, and 3D stacking of high bandwidth memory have been integrated for a high performance AI computer system via the data bus. However, it is very challenging to improve the AI system further by using the traditional data bus system due to geometric limits.

Therefore, 3D integration of GPU and high bandwidth memory is believed to have a good potential to significantly improve AI system performance because it can provide a much greater number of interconnects than the data bus and allow for a much shorter interconnect length. However, there has existed no technological solution to effectively dissipate the heat created in the 3D integrated AI system until now. The current advanced GPU consumes as much as 700 watts of electricity, making heat dissipation very challenging.

In this disclosure, a thermoelectric cooling device is monolithically formed on an IC. By using monolithic fabrications of GPU, high bandwidth memory, and thermoelectric cooler into one chip, data transfer rates will be much faster than the current bus structure allows, and without heat dissipation issues.

Therefore, by using monolithic 3D fabrication technology and the thermoelectric cooling method disclosed in this invention, AI computer system performance will be tremendously improved.

### SUMMARY

Devices of AI computer systems using thermoelectric-cooled IC are provided herein. in one embodiment, the AI computer system includes a monolithic 3D chip consisting of a thermoelectric-cooled GPU and a high bandwidth memory.

In one embodiment, a thermoelectric cooler is fabricated on the same wafer as the IC. The cold side of the thermoelectric cooler is in the same area of the IC for the benefit of effectively dissipating the heat created by the IC. In addition, the hot side can be dispensed into a heat exchanger where cooling fluid can take heat out of the AI computer area.

One important property of the AI computer system disclosed here is the separation of the hot side and cold side of the thermoelectric cooling device as well as the in situ cold side of the IC. This architecture has the capability to dissipate the heat created in the ICs and enable the arrangement of more connections between ICs in a chip.

Current data transfer connections between ICs use the data bus and the data transfer rate depends on the number of bits in the data bus. For the most advanced AI system, the data bus has several thousand bits. In comparison, the number of TSV connections between a thermoelectric-cooled IC and a memory IC could be 10 to 50 times higher, unlocking much greater AI computer performance.

This Invention makes it possible for the AI computer system to become a vertical stack of different modules such as the CPU/GPU module, memory module, supporting module with power ICs, and input/output module. This new AI computer system structure will allow for a very compact structure with reliability and calculation power hike never before.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts one embodiment of a GPU with thermoelectric cooler and TSV through the cold side of the cooler. The thermoelectric cooler is fabricated on GPU IC using semiconductor processes.

FIG. 2 depicts one embodiment of a thermoelectric-cooled monolithic 3D computer in accordance with one embodiment of the invention.

FIG. 3 depicts one embodiment of a GPU with thermoelectric cooler and TSV through the cold side of the cooler. The GPU is also bonded a silicon on insulator (SOI) by using smart cut.

FIG. 4 depict one embodiment of a SOI-monolithic 3D computer system with thermoelectric. cooled IC and a memory IC interconnected by TSV in accordance with one embodiment of the invention.

### DETAILED DESCRIPTION

Embodiments of the present invention generally provide apparatus for integrating AI computer system. Particularly, embodiments of the present invention provide apparatus for integrated stacking of AI computer system with TSV and thermoelectric cooled IC.

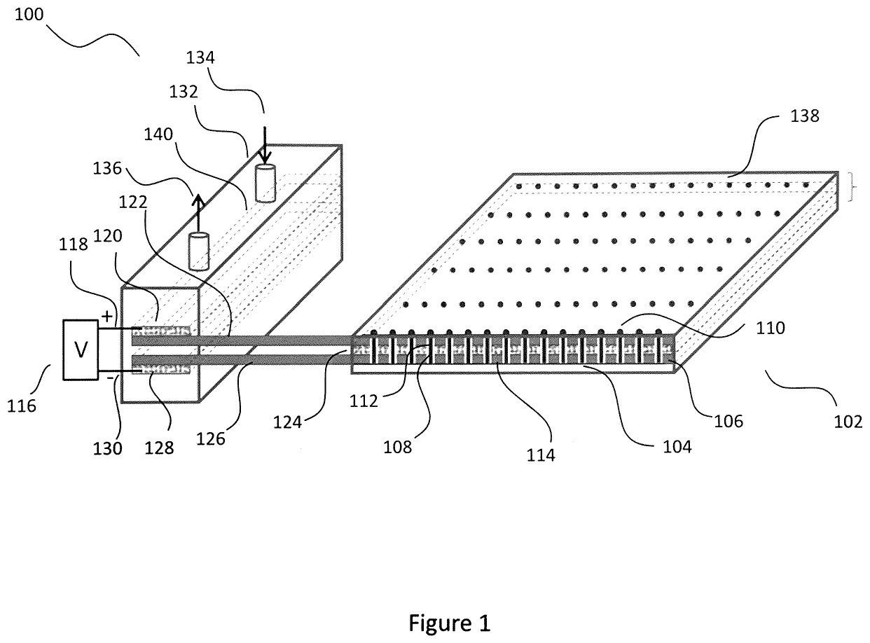

FIG. 1 schematically illustrates a thermoelectric-cooled GPU IC system 100 in accordance with one embodiment of the present invention. The GPU IC system 100 generally comprises a GPU 102. The GPU 102 is composed of IC layer 104 and thermoelectric cooler layer 106. IC layer 104 has semiconductor transistors to perform the IC function, as well as interconnections to electrically connect the transistors.

In one embodiment, thermoelectric-cooled GPU IC system 100 bas a monolithic chip and IC layer is fabricated on one silicon wafer by semiconductor processes such as patterning, implantation, etch, chemical vapor deposition (CVD), physical-vapor deposition (PVD), chemical mechanical planarization (CMP), electrochemical deposition (ECD), thinning, cleaning, etc.

In one embodiment, IC layer is composed of three sub-layers They are device sub-layer with transistors, interconnect sub-layer for connections, and bulk silicon sub-layer for physical support.

In one embodiment, TSV 108 is interconnected with IC layer 104 on one end and the other end is revealed TSV 110. Revealed TSV 110 is for connection with other device such as memory IC fabricated on the same silicon wafer. TSV 108 has the diameter range of 3-30 micrometers with length range of 20-70 micrometers for geometrically providing higher number of TSVs than current interposer.

TSV 108 is fabricated on a hole by depositing copper as conductor. The hole is made by using plasma etch or laser. Dielectric liner 112 is deposited for insulation purpose by regular semiconductor processes such as PVD or CVD. After the dielectric liner 112 is formed, copper material of TSV 108 is deposited by using ECO process.

In one embodiment, thermoelectric cooler 114 is fabricated on the surface of IC layer 104 by using regular semiconductor processes such as PVD or CVD. The thermoelectric cooler 114 can be deposited on surface of interconnect sub-layer of IC layer 104, or on the surface of bulk silicon sub-layer of IC layer 104, or on the surfaces of both sub layers.

In one embodiment, direct current (DC) power supply 116 provides DC current flowing through a loop. The DC current loop includes DC power supply 116, conductive wire 118, metal 120, N-type silicon 122, metal 124, P-type silicon 126, metal 128, and conductive wire 130.

In one embodiment, thermoelectric cooled GPU IC system 100 has heat exchanger 132 Heat fluid flows into heat exchanger 132 from inlet 134 and flow out from outlet 136, resulting in the final release of heat to environment.

In one embodiment, thermoelectric cooler 114 includes cold side 138 and hot side 140. When DC current flows in the loop mentioned above, temperature on cold side 138 becomes lower than the temperature on hot side 140. Hot side 140 is embedded in heat exchanger 132 to release heat to heat fluid by heat exchanging, and then heat is carried out of the thermoelectric-cooled GPU IC system 100 by flowing fluid. Heat created from IC layer 104 is dissipated to cold sides 138, resulting in the cooling of the GPU 102.

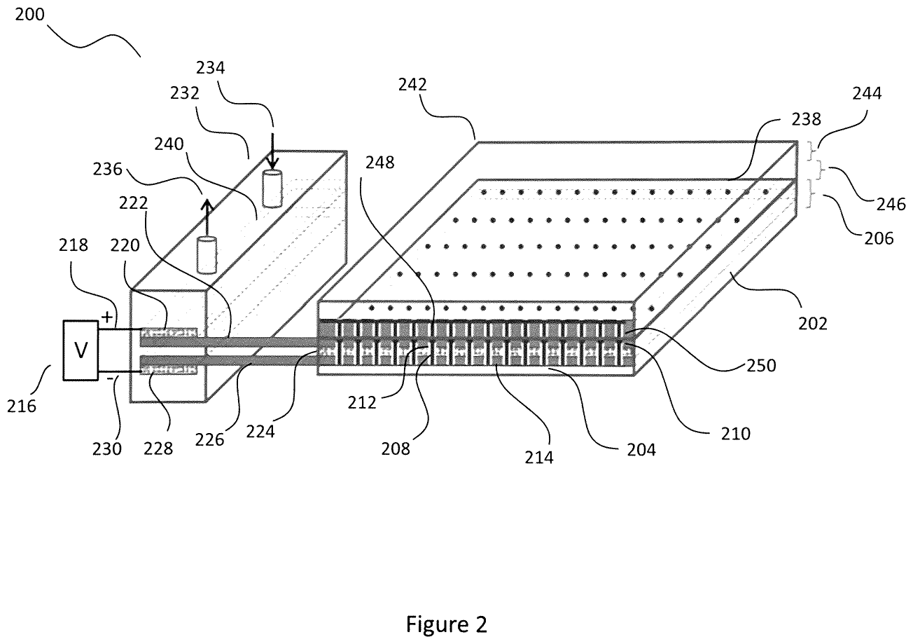

FIG. 2 shows a monolithic 3D AI computer 200 comprising thermoelectric-cooled GPU IC 202 and memory IC 242 in accordance with one embodiment of the present invention The GPU IC 202 is composed of IC layer 204 and thermoelectric cooler layer 206. IC layer 204 has semiconductor transistors to perform the IC function, as well as interconnections to electrically connect the transistors.

In one embodiment, IC layer 204 is composed of three sub-layers. They are device sub layer with transistors, interconnect sub-layer for connections, and bulk silicon sub-layer for physical support.

In one embodiment, 3D AI computer 200 is a monolithic chip. IC transistors and memory are fabricated on one silicon wafer by semiconductor processes such as patterning, implantation, etch, CVD, PVD, CMP, ECD, thinning, cleaning, etc.

In one embodiment, TSV 208 is interconnected with IC layer 204 on one end and the other end is revealed TSV 210. Revealed TSV 210 is for connection with memory IC 242. TSV 208 has the diameter range of 3-30 micrometers with length range of 20-70 micrometers for geometrically providing higher number of TSVs than current interposer.

TSV 208 is fabricated on a hole by depositing copper as conductor. The hole is made by using plasma etch or laser. Dielectric liner 212 is deposited for insulation purpose by regular semiconductor processes such as PVD or CVD. After the dielectric liner 212 is formed, copper material of TSV 208 is deposited by using ECD process.

In one embodiment, thermoelectric cooler 214 is fabricated on the surface of IC layer 204 by using regular semiconductor processes such as PVD or CVD. The thermoelectric cooler 214 can be deposited on surface of interconnect sub-layer of IC layer 204, or on the surface of bulk silicon sub-layer of IC layer 204, or on the surfaces of both sub-layers.

In one embodiment, direct current (DC) power supply 216 provides DC current flowing through a loop. The DC current loop includes OC power supply 216, conductive wire 218, metal 220, N-type silicon 222, metal 224, P-type silicon 226, metal 228, and conductive wire 230.

In one embodiment, 3D AI computer 200 has heat exchangers 232. Heat fluid flows into heat exchanger 232 from inlet 234 and flow out from outlet 236, resulting in the final release of heat to environment.

In one embodiment, thermoelectric cooler 214 includes cold side 238 and hot side 240. When DC current flows in the loop mentioned above, temperature on cold side 238 becomes lower than the temperature on hot side 240. Hot side 240 is embedded in heat exchanger 232 to release heat to heat fluid by heat exchanging, and then heat is carried out of the thermoelectric cooled 3D IC computer 200 by flowing fluid. Heat created from IC layer 204 is dissipated to cold sides 238, resulting in the cooling of the GPU IC 202.

In one embodiment, memory IC 242 has memory device layer 244, memory bulk silicon layer 246, and memory TSV 248. Memory TSV 248 is located in memory bulk silicon layer 246. Memory TSV 248 is interconnected with memory device layer 244 on one end and the other end is revealed memory TSV 250 on the surface of memory bulk silicon layer 246.

In one embodiment, GPU IC 202 and memory IC 242 are three dimensionally fabricated on a silicon wafer. GPU IC 202 and memory IC 242 are interconnected by TSV 248 and TSV 208. In one embodiment, TSV 208 is fabricated on GPU IC 202 with the revealed TSV 210. Following is the fabrication of memory IC 242. After memory IC is fabricated, memory TSV 248 is fabricated with an accurate alignment with TSV 208. Finally memory TSV 248 and TSV 208 are connected and become one TSV.

TSV 208 and memory TSV 248 have the diameter range of 3-30 micrometers with length range of 20-70 micrometers. The structure allows higher number of TSV number than current interposer and shorter distances of interconnection between GPU IC 202 and memory IC 242

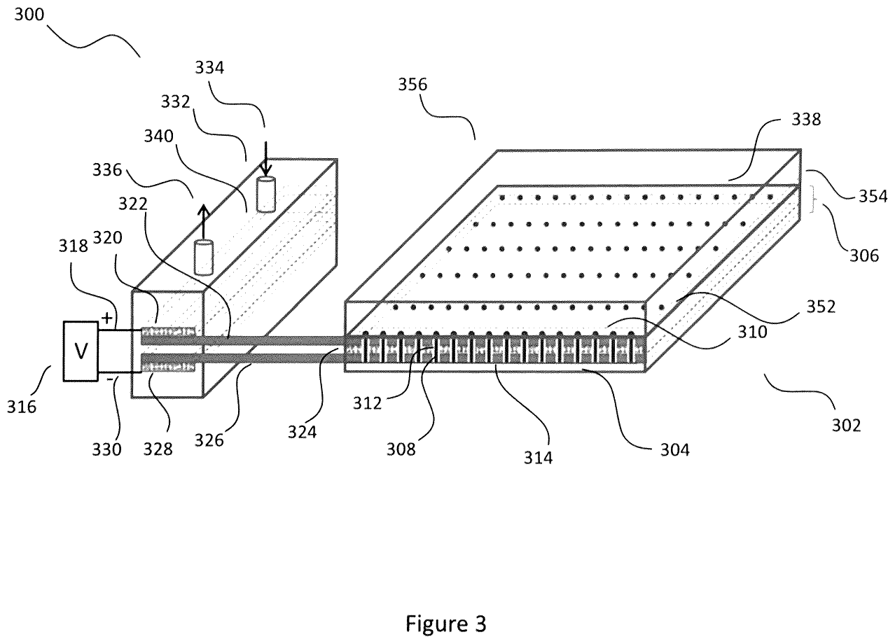

FIG. 3 shows a monolithic SOI-3D chip 300 comprising thermoelectric-cooled GPU IC 302 and SOI 356 in accordance with one embodiment of the present invention. The GPU IC 302 comprises IC layer 304 and thermoelectric cooler layer 306. IC layer 304 has semiconductor transistors to perform the IC function, as well as interconnections to electrically connect the transistors.

In one embodiment, SOI-3D chip 300 is a monolithic chip and SOI 356 is bonded to GPU IC 302 by using smart cut. Smart cut is a popular method in semiconductor industry. Chip 300 is finished with a thin silicon oxide layer on surface. Smart cut transfers a very thin layer of crystalline silicon material onto GPU IC 302. SOI is very thin so that GPU IC 302 is similar to a monolithic chip after SOI.

In one embodiment, IC layer 304 is composed of three sub layers. They are device sub-layer with transistors, interconnect sub-layer for connections, and bulk silicon sub-layer for physical support.

In one embodiment, TSV 308 is interconnected with IC layer 304 on one end and the other end is revealed TSV 310. Revealed TSV 310 is for connection with devices on SOI 356 after devices are fabricated. TSV 308 has the diameter range of 3-30 micrometers with length range of 20-70 micrometers for geometrically providing higher number of TSVs than current interposer.)

TSV 308 is fabricated on a hole by depositing copper as conductor. The hole is made by using plasma etch or laser. Dielectric liner 312 is deposited for insulation purpose by regular semiconductor processes such as PVD or CVD. After the dielectric liner 312 is formed, copper material of TSV 308 is deposited by using ECD process.

In one embodiment, thermoelectric cooler 314 is fabricated on the surface of IC layer 304 by using regular semiconductor processes such as PVD or CVD. The thermoelectric cooler 314 can be deposited on surface of interconnect sub layer of IC layer 304, or on the surface of bulk silicon sub-layer of IC layer 304, or on the surfaces of both sub-layers.

In one embodiment, direct current (DC) power supply 316 provides OC current flowing through a loop. The DC current loop includes DC power supply 316, conductive wire 318, metal 320, N-type silicon 322, metal 324, P-type silicon 326, metal 328, and conductive wire 330.

In one embodiment, SOI-3D chip 300 has heat exchangers 332. Heat fluid flows into heat exchanger 332 from inlet 334 and flow out from outlet 336, resulting in the final release of heat to environment.

In one embodiment, thermoelectric cooler 314 includes cold side 338 and hot side 340. When DC current flows in the loop mentioned above, temperature on cold side 338 becomes lower than the temperature on hot side 340. Hot side 340 is embedded in heat exchanger 332 to release heat to heat fluid by heat exchanging, and then heat is carried out of the thermoelectric-cooled SOI-3D chip 300 by flowing fluid. Heat created from IC layer 304 is dissipated to cold sides 338, resulting in the cooling of the GPU IC 302.

In one embodiment. SOI 356 is for memory device fabrication. SOI 356 composes dielectric layer 352 and crystalline silicon layer 354 for memory device fabrication in following process.

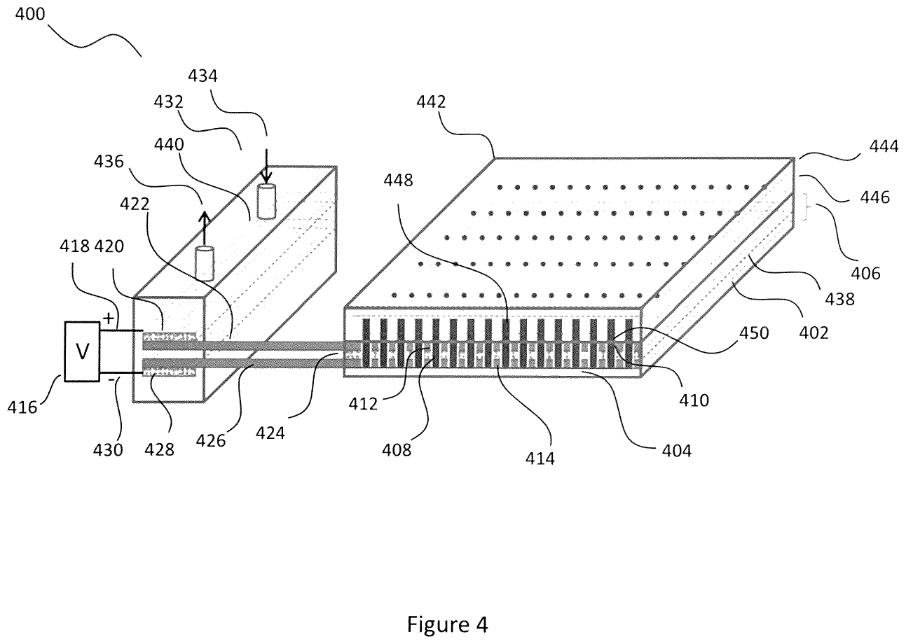

FIG. 4 shows a monolithic. SOI-3D AI computer 400 comprising thermoelectric-cooled GPU IC 402 and memory IC 442 in accordance with one embodiment of the present invention. The GPU IC 402 is composed of IC layer 404 and thermoelectric cooler layer 406. IC layer 404 has semiconductor transistors to perform the IC function, as well as interconnections to electrically connect the transistors.

In one embodiment, IC layer 404 is composed of three sub-layers. They are device sub-layer with transistors, interconnect sub-layer for connections, and bulk silicon sub-layer for physical support.

In one embodiment, SOI-3D AI computer 400 is a monolithic chip and IC transistors and memory are fabricated on one silicon wafer by semiconductor processes such as patterning, implantation, etch, CVD, PVD, CMP, ECD, thinning, cleaning, etc.

In one embodiment, TSV 408 is interconnected with IC layer 404 on one end and the other end is revealed TSV 410. Revealed TSV 410 is for connection with memory IC 442. TSV 408 has the diameter range of 3-30 micrometers with length range of 20-70 micrometers for geometrically providing higher number of TSVs than current interposer.

TSV 408 is fabricated on a hole by depositing copper as conductor. The hole is made by using plasma etch or laser Dielectric liner 412 is deposited for isolation purpose by regular semiconductor processes such as PVD or CVD. After the dielectric liner 412 is formed, copper material of TSV 408 is deposited by using ECD process.

In one embodiment, thermoelectric cooler 414 is fabricated on the surface of IC layer 404 by using regular semiconductor processes such as PVD or CVD. The thermoelectric cooler 414 can be deposited on surface of interconnect sub-layer of IC layer 404, or on the surface of bulk silicon sub-layer of IC layer 404, of on the surfaces of both sub-layers.

In one embodiment, direct current (DC) power supply 416 provides DC current flowing through a loop. The DC current loop includes DC power supply 416, conductive wire 418, metal 420, N-type silicon 422, metal 424, P-type silicon 426, metal 428, and conductive wire 430.

In one embodiment, SOI-3D AI computer 400 has heat exchangers 432. Heat fluid Blows into heat exchanger 432 from inlet 434 and flows out from outlet 436, resulting in the final release of heat to environment.

In one embodiment, thermoelectric cooler 414 includes cold side 438 and hot side 440. When DC current flows in the loop mentioned above, temperature on cold side 438 becomes lower than the temperature on hot side 440. Hot side 440 is embedded in heat exchanger 432 to release heat to heat fluid by heat exchanging, and then heat is carried out of the thermoelectric-cooled SOI-3D AI computer 400 by flowing fluid. Heat created from IC layer 404 is dissipated to cold sides 438, resulting in the cooling of the GPU IC 402.

In one embodiment, memory chip 442 has memory device layer 444, memory bulk silicon layer 446, and memory TSV 448. Memory TSV 448 is located in memory bulk silicon layer 446. Memory TSV 448 is interconnected with memory device layer 444 on one end and the other end is revealed memory TSV 450.

In one embodiment, GPU IC 402 and memory IC 442 are three-dimensionally fabricated on a silicon wafer. GPU IC 402 and memory IC 442 are interconnected by TSV 448 and TSV 408. In one embodiment, TSV 408 is fabricated on GPU IC 402 with the revealed TSV 410. After memory IC is fabricated, memory TSV 448 is fabricated with an accurate alignment with TSV 408. Finally memory TSV 448 and TSV 408 are connected and become one TSV.

TSV 408 and memory TSV 448 have the diameter range of 3-30 micrometers with length range of 20-70 micrometers. The structure allows higher number of TSV number than current Interposer and shorter distances of interconnection between GPU IC 402 and memory IC 442.

What is claimed is:

1. A monolithic 3D computer, comprising:
A processing unit IC, wherein the processing unit IC is fabricated on a silicon wafer;
A memory IC, wherein the memory IC is fabricated on the silicon wafer;
A thermoelectric cooler, wherein the thermoelectric cooler is fabricated on the silicon wafer;
A plurality of TSVs, wherein the TSVs interconnect the processing unit IC and the memory IC.

2. The monolithic 3D computer of claim 1, wherein the monolithic 3D computer is an artificial intelligence computer.

3. The monolithic 3D computer of clan 1, wherein the processing unit IC is a GPU comprising: a device layer comprising a plurality of transistors; a thermoelectric cooler comprising a cold side and a hot side, wherein the cold side dissipates heat created from the device layer, a plurality of TSV's wherein first ends are connected to the device layer, second ends are connected to the memory IC.

4. The monolithic 3D computer of claim 1, wherein the TSV is a through the cold side via.

5. The monolithic 3D computer of claim 1, wherein the memory IC is a high bandwidth memory IC.

6. The monolithic 3D computer of claim 1, wherein the processing unit IC is a CPU comprising: a device layer comprising a plurality of transistors, a thermoelectric-cooler comprising a cold side and a hot side, wherein the cold side dissipates heat created from the device layer, the hot side transfers heat to environment; a plurality of TSV wherein first ends are connected to the device layer, second ends are connected to the memory IC.

7. The monolithic 3D computer system of claim 1, wherein the memory IC is a static random access memory (SRAM).

8. The monolithic 3D computer of claim 1, wherein the memory IC is a DRAM.

9. The monolithic 3D computer of claim 1, wherein the processing unit IC is a GPU.

10. The monolithic 3D computer of claim 1, wherein the processing unit IC is a CPU.

11. A 3D computer, comprising:
A processing unit IC, wherein the processing unit IC is fabricated on a silicon wafer;
A silicon an insulator, wherein the silicon on insulator is bonded to the silicon wafer using a smart cut;
A memory IC, wherein the memory IC is fabricated on the silicon on insulator;
A thermoelectric cooler, wherein the thermoelectric cooler is fabricated on the silicon wafer;
A plurality of TSVs, wherein the TSVs interconnect the processing unit IC and the memory IC.

12. The 3D computer of claim 11, wherein the 3D computer is an artificial intelligence computer.

13. The 3D computer of claim 11, wherein the processing unit IC is a GPU comprising: a device layer comprising a plurality of transistors; a thermoelectric cooler comprising a cold side and a hot side, wherein the cold side dissipates heat created from the device layer; a plurality of TSVs wherein first ends are connected to the device layer, second ends are connected to the memory IC.

14. The 3D computer of claim 11, wherein the TSV is a through-the-cold-side via.

15. The 3D computer of claim 11, wherein the memory IC is a high bandwidth memory IC.

16. The 3D computer of claim 11, wherein the processing unit IC is a CPU comprising: a device layer;
a thermoelectric-cooler comprising a cold side and a hot side, wherein the cold side dissipates heat created from the device layer, the hot side transfers heat to environment; a plurality of TSVs wherein first ends are connected to the device layer, second ends are connected to the memory IC.

17. The 3D computer system of claim 11, wherein the memory IC is a SRAM.

18. The 3D computer of claim 1, wherein the memory IC is a DRAM.

19. The 3D computer of claim 11, wherein the processing unit IC is a GPU.

20. The 3D computer of claim 11, wherein the processing unit IC is a CPU.
